(19) United States
(12) Patent Application Publication
(10) Pub. No.: US 2023/0035681 A1
(43) Pub. Date: Feb. 2, 2023

(54) SHRINK-FIT CHUCK WITH NOVEL DAMPING, METHOD OF USING THE CHUCK AND TOOL-CLAMPING SYSTEM

(71) Applicant: Franz Haimer Maschinenbau KG, Igenhausen (DE)

(72) Inventor: Franz Haimer, Igenhausen (DE)

(21) Appl. No.: 17/860,383

(22) Filed: Jul. 8, 2022

(30) Foreign Application Priority Data
Jul. 30, 2021 (DE) 10 2021 119 935.2

(51) Int. Cl. B23P 11/02; B23B 31/117

(52) U.S. Cl. CPC B23P 11/027; B23B 31/1179

(57) ABSTRACT

A clamping chuck for clamping tools having a tool shank includes a sleeve portion which is open at its free end, is preferably composed of electrically conductive material and forms a tool-holding fixture for frictionally locking fixing of the tool shank in a press fit by shrink-fitting. The sleeve portion, preferably over an entire axial length of the tool-holding fixture, includes an inner sleeve and an outer sleeve. The outer sleeve receives the inner sleeve in an operationally ready state, is joined thereto without play, and is preferably also composed of an electrically conductive material.

### CROSS-REFERENCE TO RELATED APPLICATION

This application claims the priority, under 35 U.S.C. § 119, of German Patent Application DE 10 2021 119 935.2, filed Jul. 30, 2021; the prior application is herewith incorporated by reference in its entirety.

### FIELD AND BACKGROUND OF THE INVENTION

The invention relates to a clamping chuck for clamping tools having a tool shank, including a sleeve portion which is open at its free end, is preferably composed of electrically conductive material and forms a tool-holding fixture for frictionally locking fixing of the tool shank in a press fit by shrink-fitting. The invention also relates to a method of using the clamping chuck for high-speed cutting, in particular for high-speed milling, and a tool-clamping system including at least one tool-clamping chuck and a shank tool.

Clamping chucks in the form of shrink-fit chucks are very well established in practice because they can apply very high holding forces with little effort. In addition, they provide the possibility of holding the clamped tool with a high degree of flexural rigidity in such a way that the tool is precisely guided and produces highly accurate geometry on the workpiece during the cutting operation. At the same time, however, they frequently clamp the tool shank in a very rigid or hard manner, as a result of which vibration problems gain in significance.

The quality of the clamping of a shank tool is of great importance for the machining quality to be achieved by the tool and frequently also for the tool life.

That is all the more true of high-speed cutting of metals, in particular at a cutting speed of more than 800 m/min or even more than 1100 m/min.

The quality of the clamping also depends, inter alia, on how well vibrations which may occur can be damped. A substantial source of such vibrations can be, for example, the rapid change in the number of milling cutting edges currently in engagement in a chip-removing manner with the workpiece. They may result, for example, in considerably adverse torsional vibrations.

Other vibrations that are, however, likewise damaging can result from the tendency of a shank tool, and in particular of an end milling cutter, to roll during operation. Rolling is understood as meaning the slight elastic deformation of the shank that recurs with each revolution and changes locally in the course of the revolution due to contact with the workpiece under the load of the feed.

### SUMMARY OF THE INVENTION

It is accordingly an object of the invention to provide a shrink-fit tool-clamping chuck with novel damping, a method of using the chuck and a tool-clamping system, which overcome the hereinafore-mentioned disadvantages of the heretofore-known chucks, methods and systems of this general type and which can apply large clamping forces and at the same time can deal better with vibrations which occur.

With the foregoing and other objects in view there is provided, in accordance with the invention, a tool-clamping chuck for clamping tools having a tool shank, including a sleeve portion which is open at its free end and is composed of preferably electrically conductive material. The sleeve portion forms a tool-holding fixture for the frictionally locking fixing of the tool shank in a press fit by shrink-fitting. According to the invention, the tool-clamping chuck is distinguished not least in that the sleeve portion—preferably at any rate over the entire axial length of the tool-holding fixture—is formed of an inner sleeve and an outer sleeve which receives the latter in the operationally ready state, is joined thereto without play, and which is preferably likewise composed of an electrically conductive material.

This configuration results in a considerable reduction in the tendency of the tool-clamping chuck for damaging vibrations.

The boundary layer at which the inner sleeve and the outer sleeve are in contact with each other in the region of the tool-holding fixture appears to be responsible for this. Not least, if metal strikes against metal, damping occurs or there is a reduced capability of transmitting vibrations. This appears not least to apply whenever the inner sleeve and the outer sleeve are in non-releasable contact with each other during normal operation, for example are pressed together, in particular because they are already pressed together prior to the clamping of a tool shank and the associated prevention of expansion, and the pressing together thereof is increased further by the clamping of the tool shank.

Furthermore, the outer sleeve can then moreover be supported axially on the clamping chuck basic body, which can be realized, for example, by using a fastening flange on the outer sleeve and a complementary annular shoulder on the clamping chuck basic body. That is to say, the fastening flange or the outer sleeve is supported axially on the clamping chuck basic body.

This configuration also contributes to a significant reduction in the tendency of the tool-clamping chuck for damaging vibrations.

The above description of advantageous refinements of the invention includes numerous features that are presented in some cases collectively in combination in the individual dependent claims. Those features may however expediently also be considered individually and combined to form further meaningful combinations.

Even though some terms are used in each case in the singular or in conjunction with a numeral in the description and/or in the patent claims, it is not the intention for the scope of the invention to be restricted to the singular or the respective numeral for those terms. Furthermore, the words “a” or “an” are to be understood not as numerals but as indefinite articles.

The characteristics, features and advantages of the invention described above, and the manner in which these are achieved, will become clearer and more comprehensible in conjunction with the following description of the exemplary embodiments of the invention that will be explained in more detail in conjunction with the drawing(s)/figure(s) (identical components and functions have the same reference signs in the drawings/figures).

The exemplary embodiments serve to explain the invention and do not restrict the invention to combinations of features indicated therein, not even with respect to functional features. In addition, features suitable for this purpose of any exemplary embodiment can also be considered explicitly in isolated form, can be removed from one exemplary embodiment, introduced into another exemplary embodiment to supplement the latter and/or can be combined with any of the claims.

### BRIEF DESCRIPTION OF THE FIGURES

FIG. 1 is a diagrammatic, longitudinal-sectional view of a tool-clamping chuck;

FIG. 2 is a cross-sectional view of the tool-clamping chuck;

FIGS. 3 and 3A are respective longitudinal-sectional and cross-sectional views of another embodiment of the tool-clamping chuck;

FIG. 4 is a longitudinal-sectional view of a further embodiment of the tool-clamping chuck; and

FIGS. 5-10 are longitudinal-sectional, cross-sectional and fragmentary views of additional embodiments of the tool-clamping chuck, in which:

FIGS. 5a, 5b, 5c and 5d show the cooling slots or cooling bores, the expansion slots and the damping body or the damping bodies,

FIGS. 6a, 6b and 6c show a variant in which the expansion slots and the damping body or damping bodies are realized,

FIGS. 7a, 7b, 7c and 7d show an embodiment which also provides the cooling slots or cooling bores, the expansion slots and the damping body or the damping bodies,

FIGS. 8a, 8b, 8c, 8d and 8e show a variant in which the cooling slots or cooling bores, the expansion slots and the damping body or the damping bodies are realized,

FIGS. 9a, 9b, 9c, 9d, 9e, 9f and 9g show the outer sleeve not fixed by screws to the inner sleeve, but rather fixed by a weld, and

FIGS. 10a, 10b, 10c, 10d, 10e, 10f and 10g show the outer sleeve screwed directly to or on the inner sleeve.

### DETAILED DESCRIPTION OF THE INVENTION

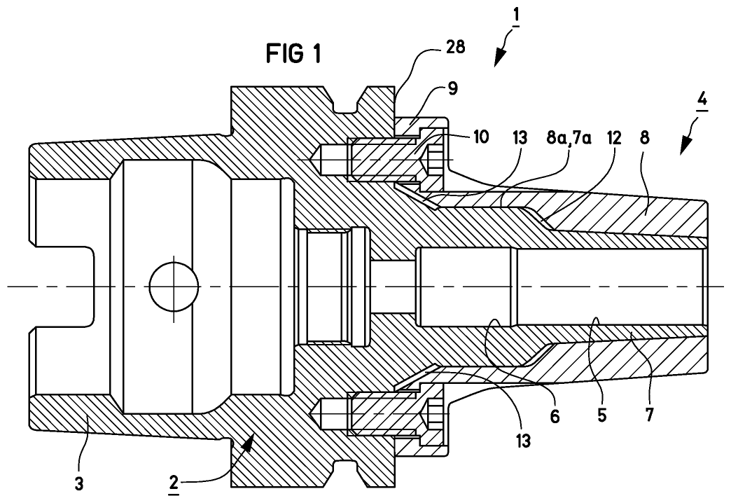

Referring now to the figures of the drawings in detail and first, particularly, to FIG. 1 thereof, there is seen a tool-clamping chuck 1 which has a clamping chuck basic body 2. In this case, the basic body 2 has, at its one end 3, a coupling for coupling to a machine tool, the coupling being by way of example an HSK coupling in FIG. 1. Alternatively, however, an SK coupling or another system is just as good. The terms HSK and SK which are preferably to be used in this way for the couplings, are familiar to people skilled in the art since they are used as standard in many places.

At its end facing away from the coupling, the tool-clamping chuck 1 forms a sleeve portion 4. A tool-holding fixture 5 which holds the shank of the tool is implemented inside the sleeve portion. In the axial direction behind the tool shank, the sleeve portion forms an outlet region 6 which is not used by the tool shank or for holding of the latter. Coolant can be introduced through the outlet region, this being stated with reference to the further figures where this is partially disclosed.

This sleeve portion 4 is constructed in such a manner and used in such a way that it can hold a tool shank in a press fit in such a way that the tool shank neither rotates nor is pulled out or slips in the axial direction, at any rate substantially, in relation to the tool holder during work with the tool. The details of the shrinking process and of the corresponding construction of the tool-clamping chuck are described in German Patent Application DE 199 15 412 A1, corresponding to U.S. Pat. Nos. 6,712,367 and 6,991,411, which are hereby fully incorporated in the subject matter of this disclosure and the features of which may therefore possibly be relied on to restrict the current claims.

The tool-clamping chuck 1 according to the invention differs therefrom in respect of its sleeve portion 4 in that the sleeve portion 4 is constructed in two layers, at any rate along the axial region in which it forms the tool-holding fixture 5, and often even furthermore beyond the region of the outlet 6, as can be seen herein in FIG. 1.

It is constructed in two layers by including an inner sleeve 7 and an outer sleeve 8. The two sleeves for their part are preferably composed of metal or steel, but preferably of different types of steel.

In one embodiment, the clamping chuck basic body 2 can be composed of different materials. Thus, the end 3 can be composed, for example, of steel, and the inner sleeve 7, which is constructed on the end 3, for example by an additive process, can be composed of a different material, e.g. aluminum.

The inner sleeve 7 and the outer sleeve 8 are connected to each other without play. This freedom from play generally also exists whenever the tool-clamping chuck 1 is still not clamping a shank, but rather is waiting unused at room temperature for its next use.

Not always, but generally and therefore particularly advantageously, the inner sleeve 7 and the outer sleeve 8 are connected to each other by a press fit. They are thereby particularly intimately in contact, with high, vibration-damping friction. The press fit can come about by the inner sleeve 7 having a conical outer circumferential surface, at least along most of the axial length of the tool-holding fixture 5.

The outer sleeve 8 then has a correspondingly conical inner circumferential surface which is complementary with respect thereto.

The outer sleeve 8 is pushed or pressed in the axial direction onto the inner sleeve 7. This can take place by using a shrinking operation and/or preferably by the further configuration shown in FIG. 1. For this purpose, the outer sleeve 8 has a centering section 8a adjoining its actual sleeve section, which is responsible for holding purposes, and an adjoining fastening flange 9. The fastening flange 9 has through holes. In this way, on the side of the clamping chuck basic body 2, the fastening flange 9 is assigned a complementary annular shoulder 28 on the clamping chuck basic body 2, through which the fastening flange 9 or the outer sleeve 8 is supported axially on the clamping chuck basic body 2—and thus contributes to the rigidity and in particular also has a vibration-damping effect.

In the present case, the annular shoulder 28 bears, at an appropriate location, blind holes which are provided with an internal thread. In this way, by tightening clamping screws 10, axial pressing between the conical surfaces of the inner sleeve 7 and the outer sleeve 8 can be achieved.

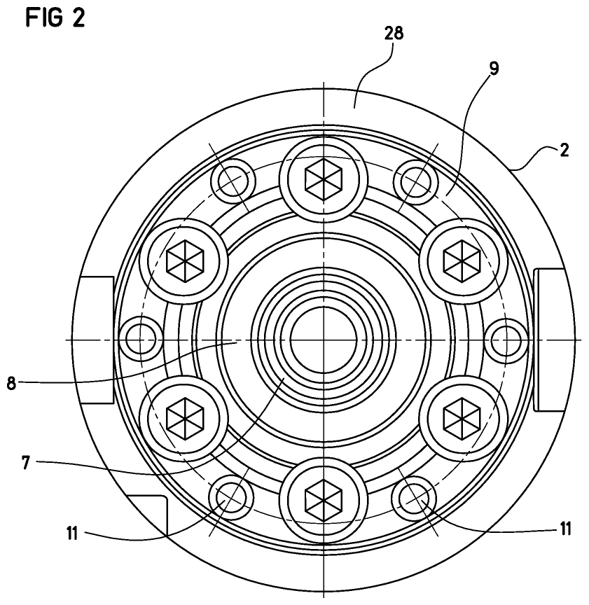

In this connection, FIG. 2 shows a further advantageous detail, namely the fact that the fastening flange 9 of the outer sleeve has further through-holes 11 with an internal thread, which serve as press-off members for removing the outer sleeve 8 again from the inner sleeve 7.

The centering section 8a, which has already been discussed, will now be discussed once again. The inner sleeve 7 or the clamping chuck basic body 2 assigned thereto likewise has a complementary centering section 7a. The structure with regard to the centering sections is selected in such a manner that the outer sleeve 8, when pushed onto the inner sleeve 7, comes to lie there with its centering section 8a on the assigned centering section 7a, even before the pressing between the inner sleeve and the outer sleeve begins. This quite considerably facilitates the pressing with the aid of the screws already discussed.

It is also notable that it has proven particularly advantageous if a transition section 12 is provided between the centering section and the actual sleeve portion, as can readily be seen in FIG. 1.

In this transition section 12, the outer sleeve 8 and the inner sleeve 7 are not in contact, even though they are completely fitted and ready for use. Advantageously, the same applies correspondingly to a region which is in the vicinity of the flange 9 and which is identified by reference sign 13 in FIG. 1. In this way too there is a distance between the preferably obliquely running inner sides of the flange 9 and the clamping chuck basic body 2. In this way and in the same manner, the transition section 12 discussed above prevents the inner sleeve and the outer sleeve from forming a solid block prematurely and in an uncontrolled manner when being joined.

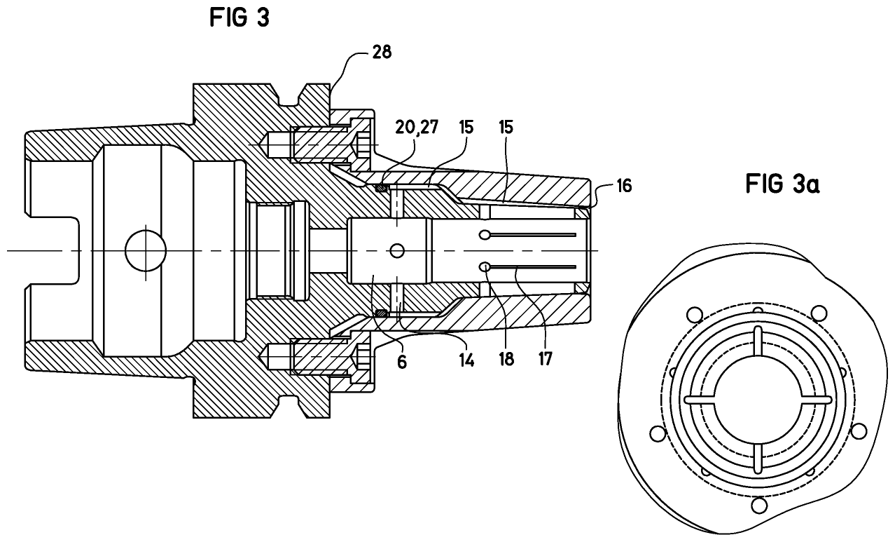

Further interesting details emerge from FIG. 3 which illustrates an alternative exemplary embodiment. What has been previously stated also applies to this exemplary embodiment, unless the description below clearly stands in the way. The description therefore refrains from repetition of that which has already been described.

This exemplary embodiment is distinguished in that it is equipped with tool cooling.

For this purpose, cooling lubricant is typically introduced from the machine tool through the coupling, which is constructed in this way as an HSK coupling, into the interior of the tool-clamping chuck. In the present case, the introduction advantageously takes place into the outlet region 6.

In this exemplary embodiment, the outlet region 6 is connected to at least one further cooling duct by radially outwardly running bores 14, or at least one individual bore of this type. This further cooling duct is formed by the fact that, for example, in the outer sleeve 8, at least one coolant groove 15 running substantially in the axial direction is formed, as FIG. 3 shows. The coolant groove opens with its opening 16 on the free end ring surface of the sleeve portion and outputs coolant from there to the tool. Typically, a plurality of coolant grooves 15, generally three or four such coolant grooves, are formed, as seen in FIG. 3a.

A sealing ring or an O-ring 20 is provided between the outer surface of the inner sleeve and the inner surface of the outer sleeve, specifically in such a manner that it is placed in an annular groove 27 provided in the outer surface of the inner sleeve, so that the coolant does not penetrate further inward between the inner sleeve and outer sleeve.

FIG. 3 shows a further interesting characteristic which can be realized in the case of a tool-clamping chuck according to the invention. As is seen, the inner sleeve can have at least one, generally a plurality of expansion slots 17. These expansion slots 17 typically do not run in the axial direction through the entire inner sleeve 7, but rather extend only along the central region thereof between the two untouched end ring surfaces. It may be expedient if each of the expansion slots 17 has a stress-concentration relief bore 18 at its one end preferably facing away from the free end of the sleeve portion.

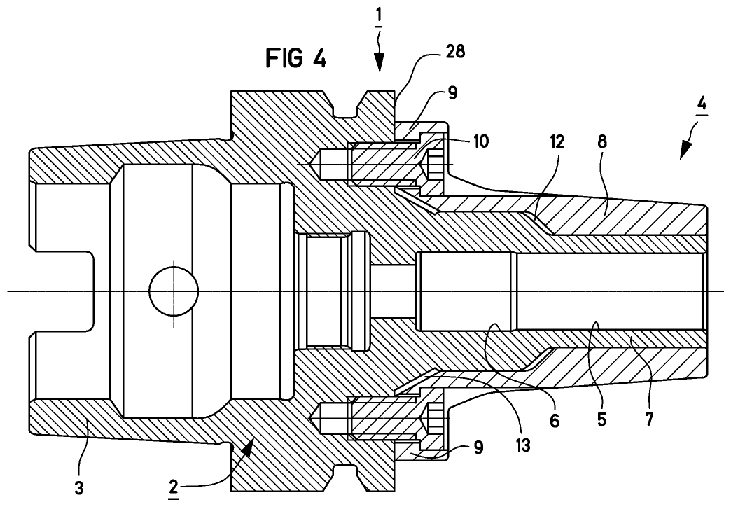

Instead of the conical pressing between the inner sleeve 7 and the outer sleeve 8, pressing as shown in FIG. 4 can be provided, for which that which has been stated up to now likewise applies unless anything different emerges from the following text. In this way, the outer circumference of the inner sleeve 7 and the inner circumference of the outer sleeve 8 are in each case of cylindrical, rather than conical, construction. Nevertheless, pressing occurs. This is because the outside diameter of the outer circumference of the inner sleeve 7 has a diametric oversize in relation to the inner circumferential diameter of the outer sleeve 8. The two parts can then be joined again by a shrinking process or by the fact that the outer sleeve 8 is pressed in the axial direction onto the inner sleeve 7, by a corresponding pressing machine.

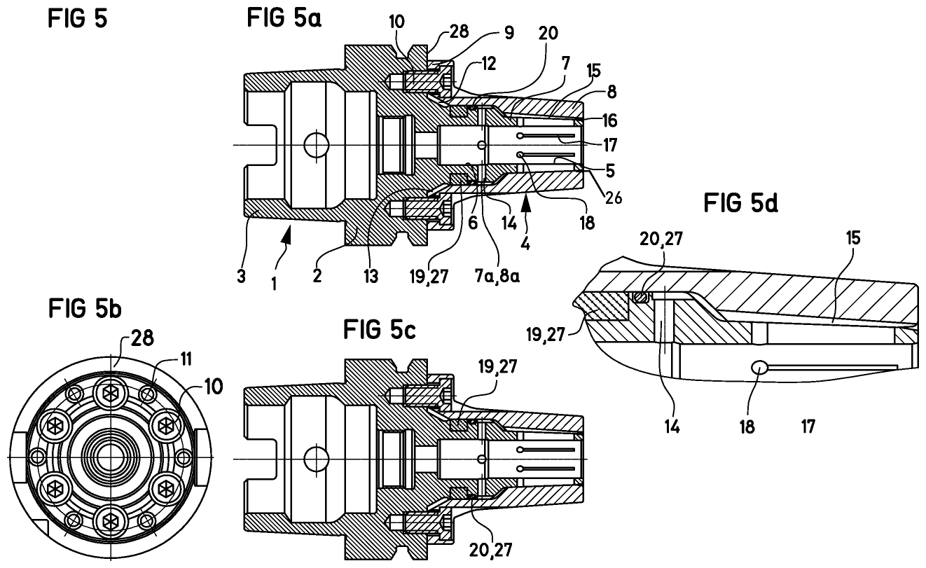

Further features also emerge from the other figures which are attached, that is FIGS. 5 to 10, or the statements there regarding the tool-clamping chuck 1, but are not currently explained in detail. Features which have been described above (from FIGS. 1 to 4) also have the same reference signs in the further figures.

An interesting variant which can be seen, for example, in FIGS. 5 to 10 includes providing a groove 27, into which a damping body 19 is placed, preferably axially following the guide region or (sometimes also referred to as the centering region) 8a or 7a, but in particular not necessarily exclusively on the tool holder basic body 2. The generally non-metallic damping body 19 is preferably made of a rubber or natural rubber or an elastomer.

FIG. 5 furthermore in particular also again shows the cooling slots or cooling bores, the expansion slots and the damping body or the damping bodies.

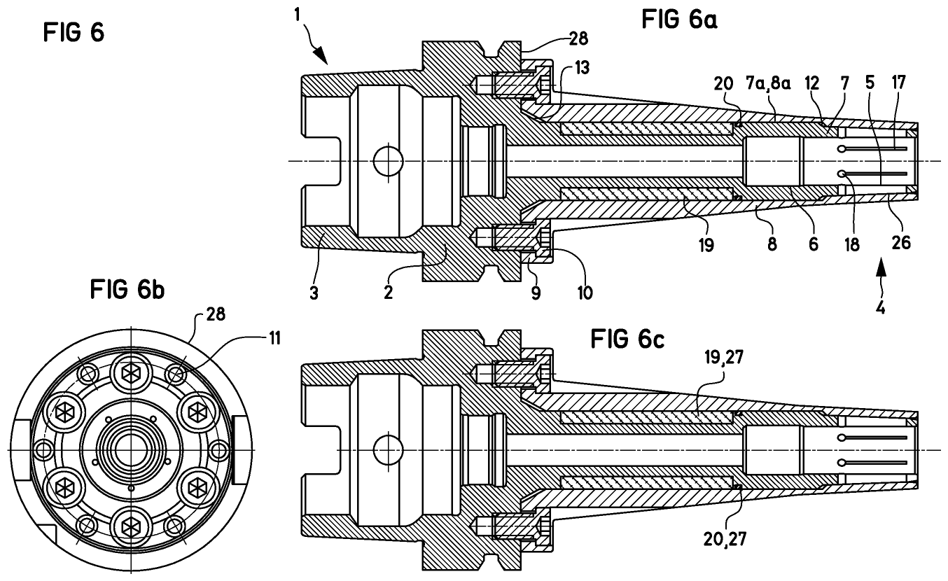

FIG. 6 in turn shows a variant in which the expansion slots and the damping body or damping bodies 19 are realized.

Furthermore, FIG. 6 shows that at least the outer circumferential surface of the inner sleeve 7 and/or at least the inner circumferential surface of the outer sleeve 8 has a coating 26 which is resistant to a shrinkage temperature and which preferably has a vibration-reducing effect.

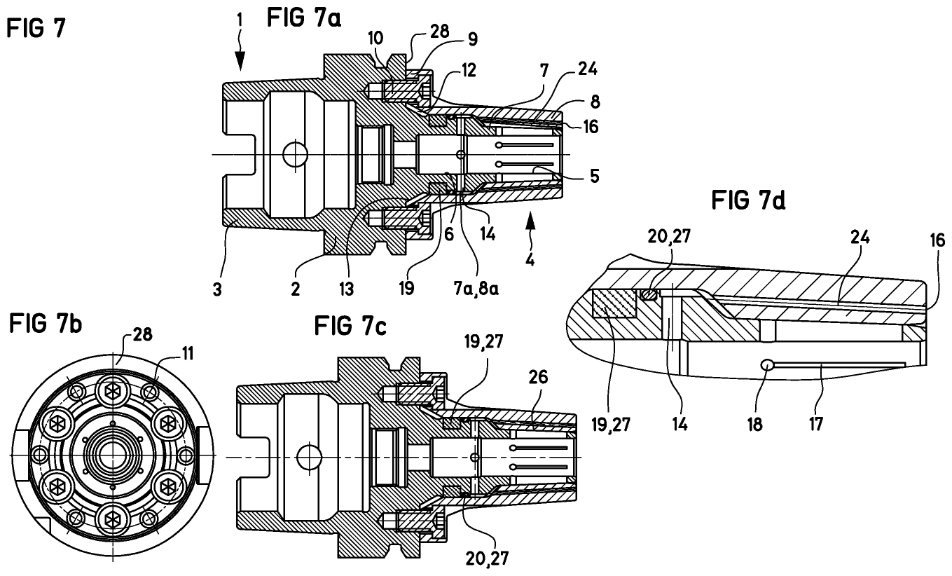

The variant according to FIG. 7 shows an embodiment which also provides the cooling slots or cooling bores, the expansion slots and the damping body or the damping bodies.

As is also shown, for example, in FIG. 7, a sealing ring or O-ring 20 placed into an annular groove 27 provided in the outer surface of the inner sleeve 7 is located between the outer circumferential surface of the inner sleeve 7 and the inner circumferential surface of the outer sleeve 8. The sealing ring or O-ring can contribute, on one hand, to preventing coolant from running inward and, on the other hand, can also have a (vibration-)damping effect.

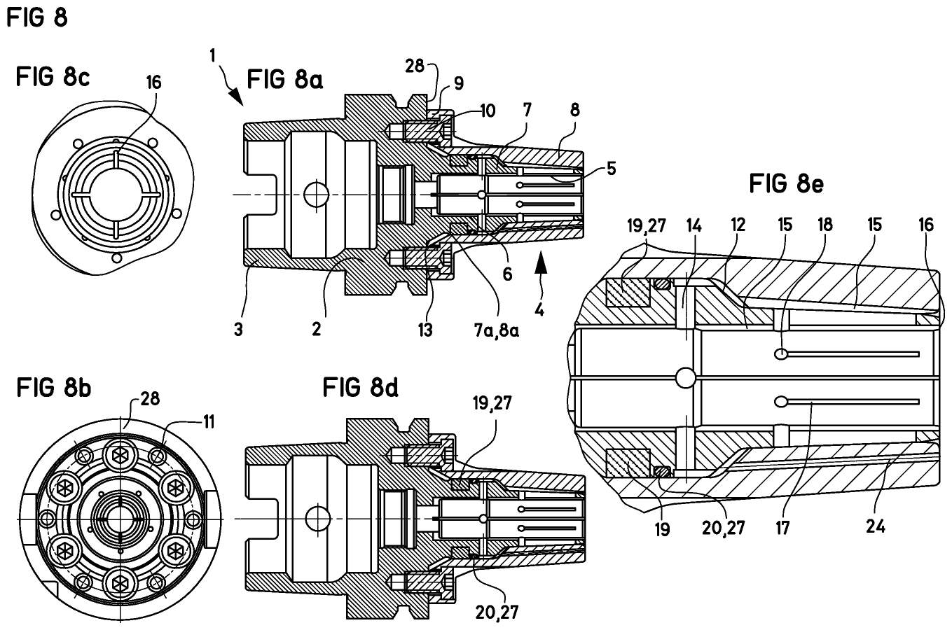

FIG. 8 also shows a variant in which the cooling slots or cooling bores, the expansion slots and the damping body or the damping bodies are realized.

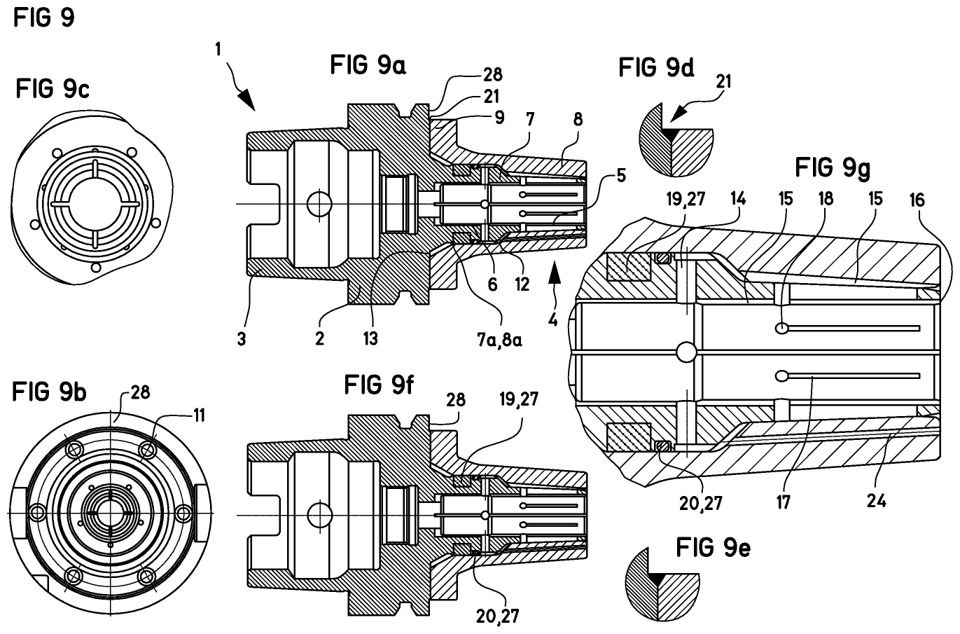

A further interesting variation which is shown in FIG. 9 is, for example, also that the outer sleeve 8 is not fixed by screws to the inner sleeve 7, but rather is fixed by a weld 21. For this purpose, it may be expedient to provide the outer sleeve with the flange which has already been discussed, but, for example, not to provide the flange with screw holes, but rather to use it to produce the weld 21 between the outer sleeve 8 and the clamping chuck basic body 2, as depicted.

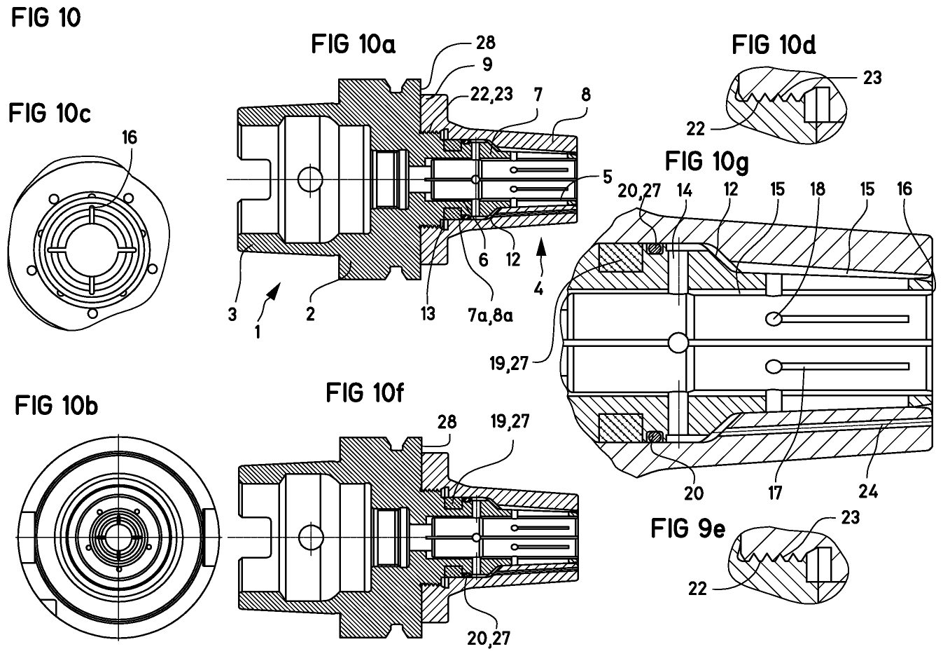

Another interesting variation which is shown in FIG. 10 is, for example, that the outer sleeve 8 is screwed directly to or on the inner sleeve 7. For this purpose, the inner sleeve 7 has an external thread 22 and the outer sleeve 8 has a complementary internal thread 23. As FIG. 10 also shows, cooling slots or cooling bores, expansion slots and damping bodies are also provided again therein.

For the sake of completeness, it should be stated that all of the features shown in the figures may be important to the invention individually or in combination, or may be at least beneficial for the invention and should therefore also be claimed at the given time.

The inner sleeve and the outer sleeve, due to their corresponding structure, can preferably both act actively (and not only transmitting/forwarding an externally generated radial pressure) in producing the press fit, as referred to at various locations within the scope of this disclosure. In some cases, the outer sleeve predominantly or substantially takes on the active production of the press fit.

By way of general significance, it is stated that protection may also be claimed for the following structure at a given time:

The tool holder basic body forms an inner sleeve 7, which is fixed thereto in one piece and preferably formed integrally or cast integrally therewith, and an outer sleeve 8 which is pushed thereon, is produced physically separately therefrom and which applies the entire, the substantially entire or the predominant part or optionally and advantageously at least 85% or 70% or 60% of the pressing force holding the tool shank.

In other words, protection can also be claimed for a construction in which no longer the tool holder basic body or clamping chuck basic body as such, but rather for the first time a shrink-fitting body, which is pushed thereon but is separate, produces the thermally generated shrink-fitting pressure, to the above-mentioned extent. In an extreme exception (but also claimed if needed), even with simple interposition of a sleeve which is then only passive and is not substantially involved in the active production of the shrink-fitting pressure and which may then be the inner sleeve, and a damping interposition between the tool shank and the outer sleeve generating a press fit for the latter.

For all of the variants, a crucial optional criterion from the aspect of damping may be that the outer sleeve and the inner sleeve are connected to each other substantially only in a frictionally locking and not form-locking manner (at any rate as seen in the circumferential direction).

This particular claim disclosure can advantageously be combined with others of the claims presented herein and/or parts thereof and/or with fragments of the description or features of the figures.

The following is a summary list of reference numerals and the corresponding structure used in the above description of the invention.

### LIST OF REFERENCE SIGNS

1 Tool-clamping chuck
2 Clamping chuck basic body
3 End
4 Sleeve portion
5 Tool-holding fixture
6 Outlet region
7 Inner sleeve
7a Centering section
8 Outer sleeve
8a Centering section
9 Fastening flange
10 Screws for pressing and optionally pressing-off
11 Through holes, press-off bore/thread
12 Transition section
13 Region in the vicinity of the flange
14 Bores
15 Coolant groove
16 Coolant groove opening
17 Expansion slots
18 Stress-concentration relief bore
19 Damping body, damping element, elastomer
20 Seal, sealing ring, O ring
21 Welded connection
22 External thread (on the inner sleeve)
23 Internal thread (on the outer sleeve)
24 Coolant bore
26 Coating
27 (Annular) groove
28 Annular shoulder

1. A tool-clamping chuck for clamping tools having a tool shank, the tool-clamping chuck comprising:
a sleeve portion having an open free end, said sleeve portion forming a tool-holding fixture for frictionally locking fixing of the tool shank in a press fit by shrink-fitting; and
said sleeve portion including an inner sleeve and an outer sleeve, said outer sleeve receiving said inner sleeve in an operationally ready state and said outer sleeve being joined to said inner sleeve without play.

2. The tool-clamping chuck according to claim 1, wherein said sleeve portion is composed of an electrically conductive material, said inner sleeve is composed of an electrically conductive material, and said inner sleeve and said outer sleeve extend over an entire axial length of said tool-holding fixture.

3. The tool-clamping chuck according to claim 1, wherein said outer sleeve is also connected to said inner sleeve by a press fit whenever the tool-clamping chuck is at room temperature and not clamping any tool shank.

4. The tool-clamping chuck according to claim 1, wherein said outer sleeve is configured, after thermal expansion of said outer sleeve and insertion of the tool shank to be clamped as intended into said inner sleeve, to be prevented from shrinking as said outer sleeve cools again and thereby substantially contributes to producing the press fit holding the tool shank.

5. The tool-clamping chuck according to claim 1, wherein said inner sleeve is configured to be under tension in a cold state and to open by deformation during thermal expansion of said outer sleeve.

6. The tool-clamping chuck according to claim 1, wherein said inner sleeve and said outer sleeve are composed of different materials or different types of steel or a hardened or use-hardened and wear-insensitive steel for said inner sleeve and a hot-working steel for said outer sleeve.

7. The tool-clamping chuck according to claim 1, which further comprises a clamping chuck basic body forming a coupling or an SK or HSK coupling to a machine tool, said inner sleeve being a non-releasable or integral part of said clamping chuck basic body.

8. The tool-clamping chuck according to claim 1, wherein:
said inner sleeve has a cylindrical or a conical outer circumferential surface;
said outer sleeve has a complementary, cylindrical or conical inner circumferential surface;
said inner sleeve and said outer sleeve are joined together by pressing; and
said inner circumferential surface of said outer sleeve has a smaller diameter than said outer circumferential surface of said inner sleeve when said outer circumferential surfaces of said inner and outer sleeves are cylindrical.

9. The tool-clamping chuck according to claim 1, wherein:
said sleeve portion forms a centering region at said inner sleeve having an enlarged outside diameter;
said outer sleeve has a complementary inside diameter forming a guide region when said inner sleeve and said outer sleeve are pressed together in an axial direction; and
said inner sleeve and said outer sleeve initially contact each other and are guided onto each other without significant pressing action and then enter into a pressing action outside said guide region over a course of further pushing together.

10. The tool-clamping chuck according to claim 9, wherein said sleeve portion forms said centering region partially or completely in a region outside an axial extent of said tool-holding fixture.

11. The tool-clamping chuck according to claim 9, wherein said guide region or centering region merges through a conical or non-conical transition section into a section of said sleeve portion associated with said tool-holding fixture.

12. The tool-clamping chuck according to claim 9, which further comprises:
a clamping chuck basic body;
said outer sleeve forming a flange with through-holes in a pushing-on direction said guide region;
said flange being faced by a complementary flange or a complementary annular shoulder with internal threaded holes or freely protruding stud bolts;
said flange or said annular shoulder being formed by said clamping chuck basic body, permitting said outer sleeve to be pressed onto said inner sleeve by screwing to said clamping chuck basic body; and
press-off devices for pressing off said outer sleeve again by using pressure screws.

13. The tool-clamping chuck according to claim 12, wherein said outer sleeve and said inner sleeve are welded or soldered to each other outside a region of said tool-holding fixture, said flange of said outer sleeve being welded or soldered to said complementary mating flange or said complementary annular shoulder of said tool-holding basic body at a transition therebetween.

14. The tool-clamping chuck according to claim 1, which further comprises a coating disposed on at least one of at least an outer circumferential surface of said inner sleeve or at least an inner circumferential surface of said outer sleeve, said coating being resistant to a shrinking temperature and having a vibration-reducing effect.

15. The tool-clamping chuck according to claim 1, wherein said inner sleeve has a slot or slots each generally ending at a distance from two end regions of said inner sleeve, at least one of said end regions forming a ring being closed in a circumferential direction, or at least one end of said slot or slots ending in a bore being diametrically larger than a slot width.

16. The tool-clamping chuck according to claim 1, which further comprises at least one coolant duct formed between said inner sleeve and said outer sleeve, said at least one coolant duct having a mouth disposed at a free end of said sleeve portion and opening substantially in an axial direction for discharging coolant to the tool, said at least one coolant duct being primarily formed by a groove in an inner circumferential surface of said outer sleeve or by a bore being circumferentially closed through said outer sleeve.

17. The tool-clamping chuck according to claim 1, which further comprises a clamping chuck basic body, said clamping chuck basic body or said inner sleeve having an insert axially behind said tool-holding fixture having a generally annular or cylindrical annular shape and being formed of damping material, rubber, elastomer or plastic.

18. The tool-clamping chuck according to claim 17, wherein said clamping chuck basic body or said inner sleeve has a sealing ring formed of a cord seal in a region before said insert.

19. The tool-clamping chuck according to claim 18, wherein at least one of said insert or said sealing ring lie in a region to be kept at least substantially free from damaging heat during shrink-fitting and shrinkage-based removal of tool shanks.

20. A method of using a tool-clamping chuck for high-speed cutting or milling, the method comprising:
providing the tool-clamping chuck according to claim 1; and
carrying out high-speed cutting or milling at a cutting speed of more than 800 m/min or at a cutting speed of more than 1100 m/min.

21. A tool-clamping chuck for clamping tools having a tool shank, the tool-clamping chuck comprising:
a sleeve portion for clamping or shrink-fitting a tool shank, said sleeve portion including an inner sleeve and an outer sleeve, said outer sleeve receiving said inner sleeve in an operationally ready state without play and said outer sleeve being joined to said inner sleeve during clamping or unclamping;
said inner and outer sleeves both being actively and substantially involved in producing a press fit holding the tool shank.

22. A tool-clamping system, comprising:
at least one tool-clamping chuck according to claim 1; and
a shank tool coordinated with said at least one tool-clamping chuck with regard to a shank nominal diameter of said shank tool.
